(19) United States
(12) Patent Application Publication
(10) Pub. No.: US 2017/0253983 A1
(43) Pub. Date: Sep. 7, 2017

(54) ARTICLES INCLUDING NICKEL-FREE COATING AND METHODS

(71) Applicant: Xtalic Corporation, Marlborough, MA (US)

(72) Inventors: John Cahalen, Arlington, MA (US); Kathy Bui, Bedford, MA (US); Zheng Zhou, Bolton, MA (US); Alan C. Lund, Framingham, MA (US)

(73) Assignee: Xtalic Corporation, Marlborough, MA (US)

(21) Appl. No.: 15/434,638

(22) Filed: Feb. 16, 2017

Related U.S. Application Data
(60) Provisional application No. 62/296,042, filed on Feb. 16, 2016.

(51) Int. Cl. C25D 5/10; A44C 27/00; H01B 1/02; H01R 4/62; C25D 7/00; B32B 15/01

(52) U.S. Cl. CPC C25D 5/10; C25D 7/005; B32B 15/018; H01B 1/026; H01B 1/023; H01R 4/62; A44C 27/006

(57) ABSTRACT

Articles including a nickel-free coating and methods for applying coatings are described herein.

### RELATED APPLICATIONS

This application claims priority to U.S. Provisional Application No. 62/296,042, filed Feb. 16, 2016, which is incorporated herein by reference in its entirety.

### FIELD OF INVENTION

The present invention generally relates to articles including a nickel-free coating and related methods (e.g., electrodeposition methods).

### BACKGROUND OF INVENTION

Many types of coatings may be applied on a base material. Electrodeposition is a common technique for depositing such coatings. Electrodeposition generally involves applying a voltage to a base material placed in an electrodeposition bath to reduce metal ionic species within the bath which deposit on the base material in the form of a metallic coating. The voltage may be applied between an anode and a cathode using a power supply. At least one of the anode or cathode may serve as the base material to be coated. In some electrodeposition processes, the voltage may be applied as a complex waveform such as in pulse plating, alternating current plating, or reverse-pulse plating. A variety of metallic coatings may be deposited using electrodeposition.

Electronic components (e.g., electrical connectors) or cosmetic components (e.g., jewelry) often include multi-layer coatings. For example, the components may include a nickel or nickel alloy barrier layer between a substrate and a precious metal (e.g., gold) top layer. However, in certain applications, nickel may be undesirable. For example, nickel can cause allergic skin reactions which is undesirable for wearable electronics, mobile devices and jewelry. Accordingly, there is a need for metallic coatings that do not include nickel.

### SUMMARY OF INVENTION

Articles including nickel-free coatings and methods are described herein.

In one aspect, an article is provided. The article comprises a substrate and a nickel-free coating formed on the substrate. The coating comprising a first metallic layer formed on the substrate. The first metallic layer comprises silver. The coating further comprises a second metallic layer formed on the first metallic layer. The second metallic layer comprises rhodium.

In one aspect, a method of forming a coated article is provided. The method comprises electrodepositing a nickel-free coating on a substrate. The coating comprising a first metallic layer formed on the substrate. The first metallic layer comprises silver. The coating further comprises a second metallic layer formed on the first metallic layer. The second metallic layer comprises rhodium.

Other aspects, embodiments, and features of the invention will become apparent from the following detailed description. All patent applications and patents incorporated herein by reference are incorporated by reference in their entirety. In case of conflict, the present specification, including definitions, will control.

### BRIEF DESCRIPTION OF DRAWINGS

FIGS. 1A-1C respectively are copies of images of cross-sections of the coatings as-deposited (FIG. 1A), after 500 hours at 150° C. (FIG. 1B) and after 500 hours at 225° C. (FIG. 1C) as described in Example 1.

FIGS. 2A-2C respectively show the interface zone (in which both atoms from the substrate and first metallic layer are present) as-deposited (FIG. 2A), after 500 hours at 150° C. (FIG. 2B) and after 500 hours at 225° C. (FIG. 2C), as described in Example 1.

FIG. 3 shows copies of photographs of Samples 1 and 2 after immersion corrosion testing at different times as described in Example 2.

### DETAILED DESCRIPTION

Articles including a nickel-free coating and methods for applying coatings are described herein. The article may include a substrate on which the multi-layer nickel-free coating is formed. In some embodiments, the coating includes multiple metallic layers. In general, a metallic layer comprises one (e.g., only one) or more metal(s). In some cases, at least some (e.g., all) of the metallic layers of the coating may be applied using an electrodeposition process. As described further below, articles including the nickel-free coating can exhibit desirable electrical and mechanical properties and characteristics including, for example, exceptional immersion corrosion properties. The articles may be used, for example, in a variety of electronic applications including wearable electronics and mobile devices. Because the coating is nickel-free, drawbacks associated with nickel (e.g., allergic skin reactions) are avoided.

As noted above, the articles described herein may include a substrate. A variety of different substrates may be suitable. In some cases, the substrate may comprise an electrically conductive material, such as a metal, metal alloy, intermetallic material, or the like. Suitable base materials include steel, stainless steel, copper and copper alloys (e.g. brass or bronze materials), aluminum and aluminum alloys, nickel and nickel alloys, polymers with conductive surfaces and/or surface treatments, and transparent conductive oxides, amongst others. In some embodiments, copper-base substrates are preferred. In some embodiments, it is preferable for the substrate to be nickel-free. In some embodiments, the substrate may be formed substantially of one material (e.g., a single material layer or a bulk material). In other embodiments, the substrate is formed of more than one layer of different materials.

The substrate may be in the form of a variety of shapes and dimensions. For example, the substrate may be strip. In some cases, the substrate may be perforated. In some cases, the substrate may be a discrete component.

The nickel-free coating can be formed on the substrate. In some cases, the coating covers substantially the entire outer surface area of the substrate. In some cases, the coating only covers a portion of the outer surface area of the substrate. For example, the coating may only cover one outer surface of the substrate. In some cases, portions of the substrate may be masked when forming the coating so that the coating is formed selectively on certain portions of the substrate while leaving other portions of the substrate uncoated. In some embodiments, one or more layers of the coating may be selectively deposited (e.g., using a mask) when being formed. That is, one or more layers (e.g., a metal layer such as Rh or Au) may cover only a portion of the outer surface area of the underlying layer or substrate.

As noted above, the coating may include multiple metallic layers.

The first layer of the coating may be a metallic layer. In some embodiments, the the first metallic layer is formed directly on the substrate. In other embodiments, an intervening layer may be formed between the substrate and the first metallic layer.

In some cases, the first metallic layer comprises silver (i.e., a silver-based metallic layer). The silver may be in the form of silver metal (e.g., substantially pure metal). In some cases, the first metallic layer comprises a silver-based alloy. Such alloys may also, for example, comprise tungsten and/or molybdenum. The silver-based alloy may be in the form of a solid solution. In some embodiments, it is preferable for the first metallic layer to comprise a silver-tungsten alloy. Other silver alloys may also be employed. In some embodiments, the weight percent of tungsten and/or molybdenum in the alloy (e.g., the remainder being substantially silver) may be at least 0.1 weight percent, at least 0.25 weight percent, at least 0.5 weight percent, at least 1 weight percent, at least 2 weight percent, at least 5 weight percent and/or at least 10 weight percent. In some embodiments, the weight percent of tungsten and/or molybdenum in the alloy (e.g., the remainder being substantially silver) may be less than 25 weight percent, less than 10 weight percent, less than 5 weight percent, less than 2.5 weight percent, less than 1 weight percent and/or less than 0.5 weight percent. It should be understood that all suitable combinations of the above-noted ranges are possible (e.g., between 0.1 and 25 weight percent; between 0.5 and 5 weight percent; between 1 and 2.5 and the like). Other weight percentages outside of this range may be used as well.

In some embodiments, the silver-based metallic layer may comprise a “hard silver”. In some cases, the Vickers hardness of the silver-based metallic layer is greater than 100 VHN; and, in some cases, greater than 150 VHN; and, in some cases greater than 200 VHN. In some cases, the Vickers hardness is less than 500 VHN and, in some cases, less than 400 VHN.

In some cases, the first metallic layer (e.g., silver-based metallic layer) may have a particular microstructure. For example, the first metallic layer may have a nanocrystalline microstructure. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. The number-average size of crystalline grains may, in some embodiments, be less than 200 nm, less than 100 nm, less than 50 nm, less than 25 nm, and/or less than 10 nm. In some embodiments, the number-average size of crystalline grains may be greater than 1 nm, greater than 5 nm, greater than 10 nm and/or greater than 25 nm. It should be understood that all suitable combinations of the above-noted ranges are possible (e.g., between 5 nm and 100 nm, between 10 nm and 50 nm, between 15 nm and 35 nm and the like). In some embodiments, the first metallic layer may have an amorphous structure. As known in the art, an amorphous structure is a non-crystalline structure characterized by having no long range symmetry in the atomic positions. Examples of amorphous structures include glass, or glass-like structures.

In some cases, the first metallic layer (e.g., silver-based metallic layer) is thermally stable. For example, the grain size of the layer remains stable at elevated temperatures. In some cases, the grain size of the first metallic layer changes by no more than about 30 nm, no more than about 20 nm, no more than about 15 nm, no more than about 10 nm, or no more than about 5 nm following exposure to a temperature of at least 150° C. for at least 500 hours. In some cases, the grain size changes by no more than about 50 nm, no more than about 30 nm, no more than about 20 nm, no more than about 15 nm, no more than about 10 nm, or no more than about 5 nm following exposure to a temperature of about 225° C. for at least 500 hours. In addition, the contact resistance of the coating may change by less than about 25%, less than about 20%, less than about 15%, less than about 10%, or less than about 5%, following exposure to a temperature of about 150° C. or 225° C. for at least about 500 hours.

In some cases, the hardness of the first metallic layer changes by no more than about 5%, no more than about 10%, no more than about 20%, no more than about 30% or no more than about 40% following exposure to a temperature of at least 150° C. for at least 500 hours. In some cases, the hardness of the first metallic layer changes by no more than about 5%, no more than about 10%, no more than about 20%, no more than about 30%, or no more than about 40% following exposure to a temperature of at least 225° C. for at least 500 hours.

Those of ordinary skill in the art will be aware of suitable methods to determine the thermal stability of a material. In some cases, the thermal stability may be determined by observing microstructural changes (e.g., grain growth, phase transition, etc.) of a material during and/or prior to and following exposure to heat. Thermal stability may be determined using differential scanning calorimetry (DSC) or differential thermal analysis (DTA), wherein a material is heating under controlled conditions. To determine changes in grain size and/or phase transitions, in situ x-ray experiments may be conducting during the heating process.

In some embodiments, the first metallic layer (e.g., silver-based metallic layer) may have limited or substantially no inter-diffusion with the underlying substrate (e.g., copper-based substrate) at elevated temperatures (e.g., 150° C., 225° C.) That is, there is limited or substantially no diffusion of substrate atoms into the first metallic layer and limited or substantially no diffusion of first metallic layer atoms into the substrate.

In some embodiments, the first metallic layer (e.g., silver-based metallic layer) may have a thickness of greater than 0.01 micrometers, greater than 0.1 micrometers, greater than 0.25 micrometers, greater than 0.5 micrometers, and/or greater than 1.0 micrometers. In some embodiments, the thickness is less than 25.0 micrometers, less than 10.0 micrometers, less than 5.0 micrometers, less than 2.5 micrometers, less than 1.0 micrometers and/or less than 0.5 micrometers. It should be understood that all suitable combinations of the above-noted ranges are possible (e.g., between 0.1 and 10.0 micrometers; between 0.25 and 5.0 micrometers; between 0.5 and 3.0 micrometers and the like).

The second layer of the coating may be a metallic layer. In some embodiments, the second metallic layer is formed directly on the first metallic layer. In other embodiments, an intervening layer (e.g., a third metallic layer as described further below) is formed between the first metallic layer and the second metallic layer.

In some embodiments, the second metallic layer comprises a platinum group metal (e.g., ruthenium, rhodium, palladium, osmium, iridium, and/or platinum). In some cases, it may be preferable for the platinum group metal to be rhodium. It has been observed that particularly attractive properties (e.g., immersion corrosion) are achievable when the multilayer stack includes a metallic layer comprising rhodium. Rhodium may be in the form of rhodium metal (e.g., substantially pure). In some cases, rhodium may be in the form of an alloy along with one or more other metals (e.g., precious metals). Other compositions may also be suitable for the second metallic layer

In some cases, the second metallic layer (e.g., layer comprising rhodium) may have a particular microstructure. For example, the second metallic layer (e.g., layer comprising rhodium) may have a nanocrystalline microstructure. The number-average size of crystalline grains may, in some embodiments, be less than 200 nm, less than 100 nm, less than 50 nm, less than 25 nm, and/or less than 10 nm. In some embodiments, the number-average size of crystalline grains may be greater than 1 nm, greater than 5 nm, greater than 10 nm and/or greater than 25 nm. It should be understood that all suitable combinations of the above-noted ranges are possible (e.g., between 5 nm and 100 nm, between 10 nm and 50 nm, between 15 nm and 35 nm and the like). In some embodiments, the fourth metallic layer may have an amorphous structure.

In some embodiments, the second metallic layer (e.g., layer comprising rhodium) may have a thickness of greater than 0.01 micrometers, greater than 0.05 micrometers, greater than 0.1 micrometers, greater than 0.25 micrometers, greater than 0.5 micrometers, greater than 1.0 micrometers and/or greater than 2.5 micrometers. In some embodiments, the thickness is less than 20 micrometers, less than 10.0 micrometers, less than 5.0 micrometers, less than 2.0 micrometers, less than 1.0 micrometers, less than 0.5 micrometers, less than 0.25 micrometers and/or less than 0.1 micrometers. It should be understood that all suitable combinations of the above-noted ranges are possible (e.g., between 0.01 and 20.0 micrometers; between 0.05 and 10.0 micrometers; between 0.05 and 4.0 micrometers; or between 0.1 micrometers and 1.0 micrometers, and the like).

In some embodiments, the coating may include a third layer. However, it should be understood that in other embodiments a third layer may not be present. The third layer of the coating may be a metallic layer. In some embodiments, the third metallic layer is formed as an intervening layer between the first metallic layer (e.g., silver-based metallic layer) and second metallic layer (e.g., layer comprising a platinum group metal such as rhodium). In other embodiments, the third metallic layer may be formed on (e.g., directly or with an intervening layer in between) the second metallic layer.

In some embodiments, the third metallic layer comprises one or more precious metals. Examples of suitable precious metals include Ru, Rh, Os, Ir, Pd, Pt, Ag, and/or Au. In some embodiments, the precious metal is selected from the group consisting Ru, Os, Ir, Pd, Pt, Ag, and Au, or combinations thereof. Gold may be preferred in some embodiments. Palladium may be preferred in some embodiments. In some embodiments, the metal layer consists essentially of one precious metal. In some embodiments, it may be preferable that the metal layer is free of tin. In some cases, the precious metal is not rhodium and/or is not ruthenium. In other cases, the metal layer may comprise an alloy that includes at least one precious metal and at least one other metal that is not a precious metal. The other metal may be selected from W, Fe, B, S, Co, Mo, Cu, Cr, Zn, and Sn, amongst others.

In some cases, the third metallic layer may have a particular microstructure. For example, the third metallic layer may have a nanocrystalline microstructure. The number-average size of crystalline grains may, in some embodiments, be less than 200 nm, less than 100 nm, less than 50 nm, less than 25 nm, and/or less than 10 nm. In some embodiments, the number-average size of crystalline grains may be greater than 1 nm, greater than 5 nm, greater than 10 nm and/or greater than 25 nm. It should be understood that all suitable combinations of the above-noted ranges are possible (e.g., between 5 nm and 100 nm, between 10 nm and 50 nm, between 15 nm and 35 nm and the like). In some embodiments, the third metallic layer may have an amorphous structure.

In some embodiments, the third metallic layer may have a thickness of greater than 0.01 micrometers, greater than 0.05 micrometers, greater than 0.1 micrometers, greater than 0.25 micrometers, greater than 0.5 micrometers, greater than 1.0 micrometers and/or greater than 5.0 micrometers. In some embodiments, the thickness is less than 20.0 micrometers, less than 10.0 micrometers, less than 5.0 micrometers, less than 2.0 micrometers, less than 1.0 micrometers, less than 0.5 micrometers, less than 0.25 micrometers and/or less than 0.1 micrometers. It should be understood that all suitable combinations of the above-noted ranges are possible (e.g., between 0.05 and 3.0 micrometers; between 0.1 micrometers and 2.0 micrometers; between 0.1 and 1.0 micrometers; between 0.25 micrometers and 0.75 micrometers, and the like).

In some embodiments, the coating includes a metallic layer comprising silver (e.g., a silver tungsten alloy) formed on (e.g., directly on) a substrate and a metallic layer comprising rhodium formed on (e.g., directly on) the metallic layer comprising silver. In some embodiments, the coating includes a metallic layer comprising silver (e.g., a silver tungsten alloy) formed on (e.g., directly on) a substrate and a metallic layer comprising gold formed on (e.g., directly on) the metallic layer comprising silver and a metallic layer comprising rhodium formed on (e.g., directly on) the metallic layer comprising gold.

As described further below in the Examples, the coating unexpectedly exhibits particularly exceptional properties including exceptional corrosion (e.g., mixed flowing gas, neutral salt spray, heat and humidity and immersion corrosion properties (e.g., with or without an applied bias)). Other particularly exceptional properties can include desirable coloration (e.g., desired shade/tone, color stability over time, etc.), excellent wear resistance, and a stable surface conductivity (e.g., a contact resistance that differs by less than 250 mOhm, less than 100 mOhm, less than 50 mOhm, less than 25 mOhm, less than 10 mOhm, less than 5 mOhm and/or less than 1 mOhm over testing as measured by EIA 364 Test Protocol).

It should be understood that the coating may include any combination of the above-described metallic layers. Also, it should be understood that the coating may include more than three layers and more than three metallic layers. However, in some embodiments, the coating may only include three metallic layers or two metallic layers. In some embodiments, the coating includes the second metallic layer as described above (e.g., layer comprising rhodium) but does not include the first metallic layer as described above; and, in some of these embodiments in which the coating includes the second metallic layer but not the first metallic layer, the coating further includes a third metallic layer as described above (e.g., a palladium layer).

As noted above, metallic layers of the coating may be formed using an electrodeposition process. Electrodeposition generally involves the deposition of a material (e.g., electroplate) on a substrate by contacting the substrate with an electrodeposition bath and flowing electrical current between two electrodes through the electrodeposition bath, i.e., due to a difference in electrical potential between the two electrodes. For example, methods described herein may involve providing an anode, a cathode, an electrodeposition bath (also known as an electrodeposition fluid) associated with (e.g., in contact with) the anode and cathode, and a power supply connected to the anode and cathode. In some cases, the power supply may be driven to generate a waveform for producing a coating, as described more fully below.

Generally, the different metallic layers may be applied using separate electrodeposition baths. In some cases, individual articles may be connected such that they can be sequentially exposed to separate electrodeposition baths, for example in a reel-to-reel process. For instance, articles may be connected to a common conductive substrate (e.g., a strip). In some embodiments, each of the electrodeposition baths may be associated with separate anodes and the interconnected individual articles may be commonly connected to a cathode.

The electrodeposition process(es) may be modulated by varying the potential that is applied between the electrodes (e.g., potential control or voltage control), or by varying the current or current density that is allowed to flow (e.g., current or current density control). In some embodiments, the coating may be formed (e.g., electrodeposited) using direct current (DC) plating, pulsed current plating, reverse pulse current plating, or combinations thereof. Pulses, oscillations, and/or other variations in voltage, potential, current, and/or current density, may also be incorporated during the electrodeposition process, as described more fully below. For example, pulses of controlled voltage may be alternated with pulses of controlled current or current density. In general, during an electrodeposition process an electrical potential may exist on the substrate (e.g., base material) to be coated, and changes in applied voltage, current, or current density may result in changes to the electrical potential on the substrate. In some cases, the electrodeposition process may include the use waveforms comprising one or more segments, wherein each segment involves a particular set of electrodeposition conditions (e.g., current density, current duration, electrodeposition bath temperature, etc.), as described more fully below.

Some embodiments of the invention involve electrodeposition methods wherein the grain size of electrodeposited materials (e.g., metals, alloys, and the like) may be controlled. In some embodiments, selection of a particular coating (e.g., electroplate) composition, such as the composition of an alloy deposit, may provide a coating having a desired grain size. In some embodiments, electrodeposition methods (e.g., electrodeposition conditions) described herein may be selected to produce a particular composition, thereby controlling the grain size of the deposited material.

In some embodiments, a coating, or portion thereof, may be electrodeposited using direct current (DC) plating. For example, a substrate (e.g., electrode) may be positioned in contact with (e.g., immersed within) an electrodeposition bath comprising one or more species to be deposited on the substrate. A constant, steady electrical current may be passed through the electrodeposition bath to produce a coating, or portion thereof, on the substrate. In some embodiments, the potential that is applied between the electrodes (e.g., potential control or voltage control) and/or the current or current density that is allowed to flow (e.g., current or current density control) may be varied. For example, pulses, oscillations, and/or other variations in voltage, potential, current, and/or current density, may be incorporated during the electrodeposition process. In some embodiments, pulses of controlled voltage may be alternated with pulses of controlled current or current density. In some embodiments, the coating may be formed (e.g., electrodeposited) using pulsed current electrodeposition, reverse pulse current electrodeposition, or combinations thereof.

In some cases, a bipolar waveform may be used, comprising at least one forward pulse and at least one reverse pulse, i.e., a “reverse pulse sequence.” In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of composition and/or grain size of the coating that is produced.

It should be understood that other techniques may be used to produce coatings as described herein, including electroless plating processes, vapor-phase processes (e.g. physical vapor deposition, chemical vapor deposition, ion vapor deposition, etc.), sputtering, spray coating, powder-based processes, slurry-based processes, etc.

As noted above, articles including the multi-layer coating can exhibit desirable properties and characteristics including, for example, exceptional immersion corrosion properties. The immersion corrosion properties described herein are measured in a three electrode temperature-controlled jacketed cell at 22° C. The cell includes a platinum wire as a counter electrode and a Ag/AgCl reference electrode in a saturated KCl solution. The sample (e.g., coated article) is immersed in a testing solution such as artificial perspiration (e.g., artificial perspiration manufactured according to ISO 3160) and a positive bias (e.g., 5 Volts) is applied to the sample. The time to failure (e.g., in minutes) is measured.

There are several types of failure that may be characterized in different ways. As used herein, the time to “initial visible failure” is defined as the test time until the first visible signs of corrosion on the sample to the naked eye.

As used herein, the time to “functional failure” is the test time until a connector formed from the sample no longer functions as defined by its mating surface having an LLCR (low level contact resistance) of greater than 10 μOhm when measured according to EIA-364-23B. In some embodiments, functional failure may be the test time until the mating surface has an LLCR of greater than 1 mOhm; in some embodiments, an LLCR of greater than 10 mOhm; in some embodiments, an LLCR of greater than 25 mOhm; in some embodiments, an LLCR of greater than 50 mOhm; in some embodiments, an LLCR of greater than 100 mOhm; and, in some embodiments, an LLCR of greater than 250 mOhm when measured according to EIA-364-23B. In some embodiments, the time to functional failure is the test time until a connector formed from the sample no longer functions as defined by its mating surface having a change in LLCR of greater than or equal to 1 mOhm; in some embodiments, a change in LLCR of greater than 10 mOhm; in some embodiments, a change in LLCR of greater than 20 mOhm; in some embodiments, a change in LLCR of greater than 50 mOhm; in some embodiments, a change in LLCR of greater than 100 mOhm; and, in some embodiments, a change in LLCR of greater than 250 mOhm, when measured according to EIA-364-23B.

As used herein, the time to “distinct corrosion” failure may be defined as the test time until the first corrosion product of a size and location as described in EIA-364-53B “Nitric Acid Vapor Test, Gold Finish Test Procedure for Electrical Connectors and Sockets” with has a frequency of greater than 2%; in some embodiments, greater than 10%; in some embodiments greater than 15%; and, in some embodiments, greater than 25%.

Those of ordinary skill in the art will recognize that visible corrosion along the edges of the multi-layer coating are often caused by “edge effects” and are often discounted as signs of failure during a given test. Those of ordinary skill in the art will also recognize that local processing defects, incorrect cleaning or activation of the sample prior to layer synthesis, or mechanically or chemically damaging exposures of the multi-layer coating prior to testing could cause a given test to be invalid regardless of the failure type being evaluated.

The exceptional immersion corrosion properties of articles including a multi-layer coating may be characterized by time(s) to failure in an immersion corrosion test. For example, in some embodiments, the time to failure (e.g., initial visible failure, functional failure and/or distinct corrosion failure) of the multi-layer coated articles is at least 5 minutes at 5 Volts in artificial perspiration; in some embodiments, at least 10 minutes at 5 Volts in artificial perspiration; in some embodiments, at least 20 minutes at 5 Volts in artificial perspiration; in some embodiments, at least 40 minutes at 5 Volts in artificial perspiration; in some embodiments, at least 80 minutes at 5 Volts in artificial perspiration; and, in some embodiments, at least 100 minutes at 5 Volts in artificial perspiration. In some embodiments, the time to initial visible failure is less than 360 minutes at 5 Volts in artificial perspiration, less than 240 minutes at 5 Volts in artificial perspiration or less than 120 minutes at 5 Volts in artificial perspiration. In some embodiments, the time to failure (e.g., initial visible failure, functional failure and/or distinct corrosion failure) of the multi-layer coated articles is at least 5 minutes at 2 Volts in artificial perspiration; in some embodiments, at least 10 minutes at 2 Volts in artificial perspiration; in some embodiments, at least 20 minutes at 2 Volts in artificial perspiration; in some embodiments, at least 40 minutes at 2 Volts in artificial perspiration; in some embodiments, at least 80 minutes at 2 Volts in artificial perspiration; and, in some embodiments, at least 100 minutes at 2 Volts in artificial perspiration. In some embodiments, the time to initial visible failure is less than 360 minutes at 2 Volts in artificial perspiration, less than 240 minutes at 2 Volts in artificial perspiration or less than 120 minutes at 2 Volts in artificial perspiration.

In some embodiments, the corrosion resistance may be assessed using tests such as ASTM B845, entitled “Standard Guide for Mixed Flowing Gas (MFG) Tests for Electrical Contacts” following the Class IIa protocol. These tests outline procedures in which coated substrate samples are exposed to a corrosive atmosphere (i.e., a mixture of NO₂, H₂S, Cl₂, and SO₂). The mixture of flowing gas can comprise 200+/−50 ppb of NO₂, 10+/−5 ppb of H₂S, 10+/−3 ppb of Cl₂, and 100+/−20 ppb SO₂. The temperature and relative humidity may also be controlled. For example, the temperature may be 30+/−1° C., and the relative humidity may be 70+/−2%.

The low-level contact resistance of a sample may be determined before and/or after exposure to a corrosive environment for a set period of time according to one of the tests described above. In some embodiments, the low-level contact resistance may be determined according to specification EIA 364-23B. In some embodiments, the coated article has reduced low-level contact resistance and/or change in low-level contact resistance after testing. Such articles may be particularly useful in electrical applications such as electrical connectors.

In some cases, the coated article may have a low-level contact resistance (LLCR) (under a load of 25 g) after 5 days exposure to mixed flowing gas according to ASTM B845, protocol Class IIa, of less than 250 mOhm; in some embodiments, less than 100 mOhm; in some embodiments, less than 50 mOhm; in some embodiments, less than 25 mOhm; in some embodiments, less than 10 mOhm; in some embodiments, less than 1 mOhm; and, in some embodiments, less than 10 μOhm.

In some cases, the coated article may have a change in low-level contact resistance (LLCR) (under a load of 25 g) after 5 days exposure to mixed flowing gas according to ASTM B845, protocol Class IIa, of less than 250 mOhm; in some embodiments, less than 100 mOhm; in some embodiments, less than 50 mOhm; in some embodiments, less than 20 mOhm; in some embodiments, less than 10 mOhm; and, in some embodiments, less than or equal to 1 mOhm. The articles can be used in a variety of applications including electronic applications (such as wearable electronics and mobile devices) or cosmetic components (such as jewelry and eyeglass frames).

The following example is for illustrative purposes only and should not be considered to be limiting.

### Example 1

This example shows the thermal stability of a nickel-free coating according to an embodiment described above (“inventive coating”).

Samples were formed by applying an inventive coating to a copper substrate using electrodeposition processes. The coating included a first metallic layer comprising a silver tungsten alloy and a second metallic layer comprising rhodium.

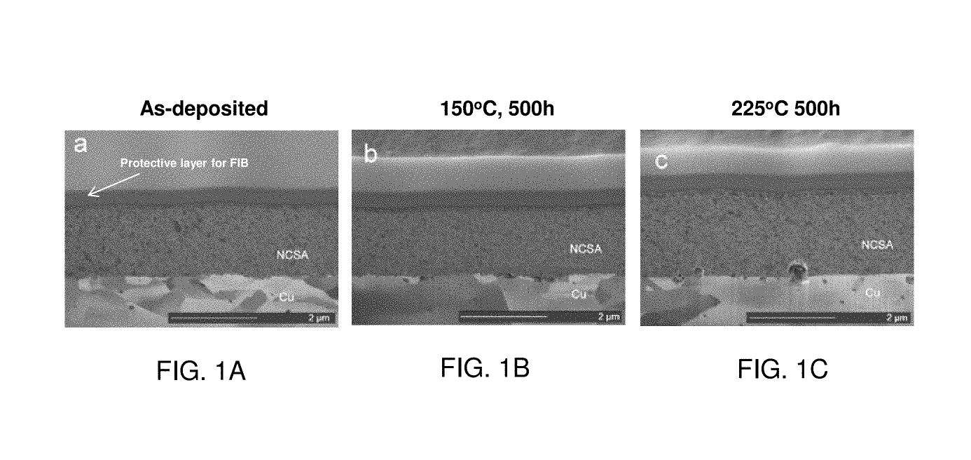

FIGS. 1A-1C respectively are copies of images of cross-sections of the coatings as-deposited (FIG. 1A), after 500 hours at 150° C. (FIG. 1B) and after 500 hours at 225° C. (FIG. 1C). The images show no apparent grain size growth at the elevated temperatures. The images also show that the stability of the interface was maintained, as shown by the straight line.

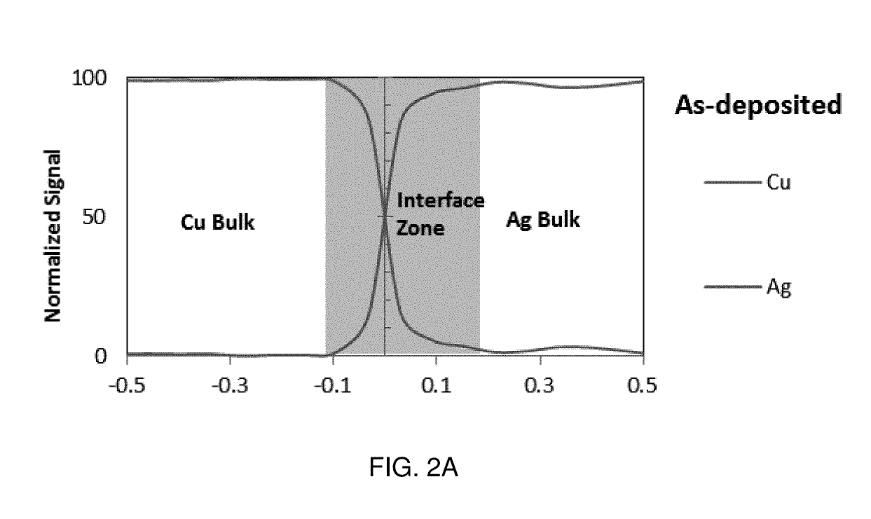

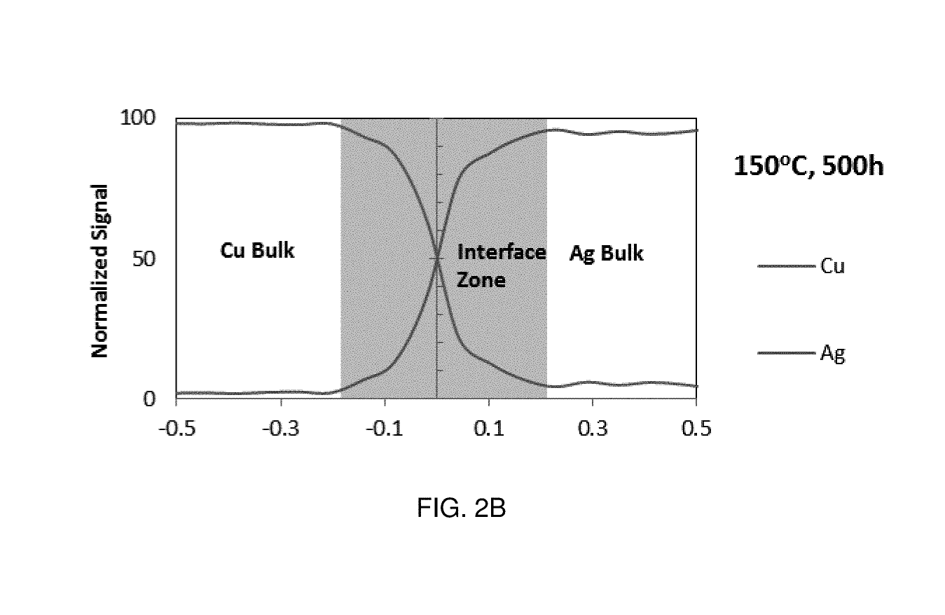

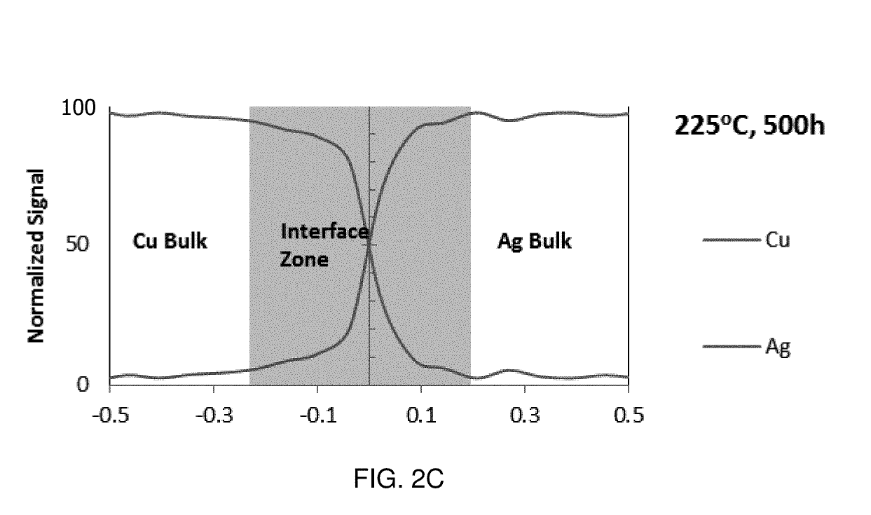

Auger line scanning was used to further study the interface of the first metallic layer and the substrate. FIGS. 2A-2C respectively show the interface zone (in which both atoms from the substrate and first metallic layer are present) as-deposited (FIG. 2A), after 500 hours at 150° C. (FIG. 2B) and after 500 hours at 225° C. (FIG. 2C). Minimal inter-diffusion was observed at the elevated temperatures. The interface zone increases by less than 0.2 micrometers between as-deposited and 500 hours at 225° C.

This example shows the excellent thermal stability of the nickel-free inventive coating.

### Example 2

This example compares the immersion corrosion performance of an article including a nickel-free coating (“inventive coating”) according to an embodiment described above to an article including a conventional coating.

Sample 1 was formed by applying an inventive coating to a substrate using electrodeposition processes. The coating included a silver tungsten alloy layer formed on a substrate, a gold layer formed on the silver tungsten alloy layer and a rhodium layer formed on the gold layer.

Sample 2 was formed by applying a conventional coating to a substrate using electrodeposition processes. The coating included a layer comprising nickel formed on a substrate and a gold layer formed on the nickel-based layer. Sample 2 is a common industry standard for high-performance applications, and would be considered by those of ordinary skill in the art to be a premium, durable connector finish.

The immersion corrosion properties of the samples were measured. The measurement utilized a three electrode temperature-controlled jacketed cell at 22° C. The cell included a platinum wire as a counter electrode and a Ag/AgCl reference electrode in a saturated KCl solution. The samples were immersed in an artificial perspiration testing solution (artificial perspiration manufactured according to ISO 3160) and a positive bias (5 Volts) is applied to the sample. The time to initial visible failure (e.g., in minutes) was measured.

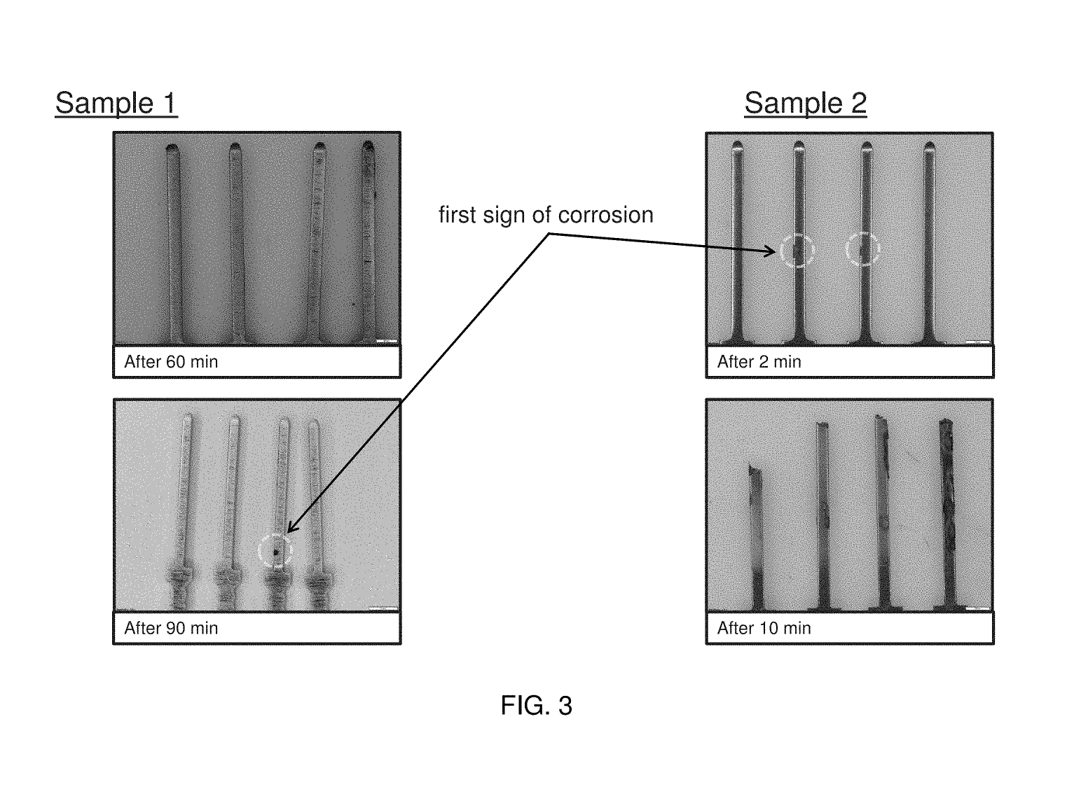

FIG. 3 are copies of photographs of Samples 1 and 2 after immersion corrosion testing at different times. Sample 1 had an initial visible failure time of 90 minutes and Sample 2 had an initial visible failure time of 2 minutes. Therefore, the sample including the inventive coating exhibited a 45× improvement as compared to the sample including the conventional coating.

1. An article comprising:
a substrate;
a nickel-free coating formed on the substrate, the coating comprising:
a first metallic layer formed on the substrate, wherein the first metallic layer comprises silver; and
a second metallic layer formed on the first metallic layer, the second metallic layer comprising rhodium.

2. A method of forming a coated article comprising
electrodepositing a nickel-free coating on a substrate, wherein the coating comprises:
a first metallic layer formed on the substrate, wherein the first metallic layer comprises silver; and
a second metallic layer formed on the first metallic layer, the second metallic layer comprising rhodium.

3. The article of method of claim 1, wherein the first metallic layer has a nanocrystalline grain structure.

4. The article of method of claim 1, wherein the first metallic layer has a Vickers hardness of greater than 150 VHN.

5. The article of method of claim 1, wherein the article is an electrical connector.

6. The article of method of claim 1, wherein the article is a cosmetic component.

7. The article of method of claim 1, wherein the article is jewelry.

8-9. (canceled)

10. The article or method of claim 1, wherein the first metallic layer comprises a silver-based alloy.

11. The article or method of claim 1, wherein the silver-based alloy further comprises molybdenum and/or tungsten

12. The article or method of claim 1, wherein the silver-based alloy comprises a silver tungsten alloy.

13. The article or method of claim 1, wherein the first metallic layer grain size changes by no more than about 50 nm following exposure to a temperature of about 225° C. for at least 500 hours.

14-16. (canceled)

17. The article or method of claim 1, wherein the coating comprises an intervening layer formed between the first metallic layer and the second metallic layer.

18. The article or method of claim 1, wherein the second metallic layer comprises a platinum group metal.

19. The article or method of claim 1, wherein the second metallic layer comprises rhodium.

20-21. (canceled)

22. The article of method of claim 1, wherein the coating comprises a third metallic layer.

23. The article or method of claim 1, wherein the third metallic layer is an intervening layer between the first metallic layer and the second metallic layer.

24-25. (canceled)

26. The article or method of claim 1, wherein the third metallic layer comprises a precious metal.

27-29. (canceled)

30. The article or method of claim 1, wherein the first metallic layer comprises a silver-based alloy and the second metallic layer comprises rhodium.

31. The article of method of claim 1, wherein the first metallic layer comprises a silver-based alloy, the second metallic layer comprises rhodium and the third metallic layer comprises gold.

32. The article or method of claim 1, wherein the article has a time to initial visible failure in an immersion corrosion test of at least 20 minutes at 5 Volts in artificial perspiration.
